(19) United States
(12) Patent Application Publication
(10) Pub. No.: US 2016/0298465 A1
(43) Pub. Date: Oct. 13, 2016

(54) GAS TURBINE ENGINE COMPONENT COOLING PASSAGE WITH ASYMMETRICAL PEDESTALS

(71) Applicant: UNITED TECHNOLOGIES CORPORATION, Farmington, CT (US)

(72) Inventors: Charles Thistle, Middletown, CT (US); Lane Thornton, Meriden, CT (US)

(21) Appl. No.: 15/101,244

(22) PCT Filed: Dec. 2, 2014
(86) PCT No.: PCT/US2014/068058

§ 371 Date: Jun. 2, 2016

Related U.S. Application Data
(60) Provisional application No. 61/915,213, filed on Dec. 12, 2013.

(51) Int. Cl. F01D 5/18; F23R 3/00; F01D 5/30; F01D 25/12; F01D 5/08

(52) U.S. Cl. CPC F01D 5/187; F01D 25/12; F01D 5/081; F01D 5/186; F01D 5/3007; F23R 3/002; F05D 2220/32; F05D 2260/202; F05D 2230/50; F05D 2240/12; F05D 2240/35; F05D 2240/55

(57) ABSTRACT

A gas turbine engine component includes spaced apart walls that provide a cooling passage that extends in a first direction. A pedestal is arranged in the cooling passage and interconnects the walls in a thickness direction that is transverse to the first direction. The pedestal is asymmetrical in the thickness direction.

### CROSS-REFERENCE TO RELATED APPLICATIONS

This application claims priority to U.S. Provisional Application No. 61/915,213, which was filed on Dec. 12, 2013 and is incorporated herein by reference.

### BACKGROUND

This disclosure relates to gas turbine engine component cooling passages with pedestals.

A gas turbine engine uses a compressor section that compresses air. The compressed air is provided to a combustor section where the compressed air and fuel is mixed and burned. The hot combustion gases pass over a turbine section to provide work that may be used for thrust or driving another system component.

Pedestal arrays, made up of some pattern of individual pedestals, are a common design feature of modern turbine airfoils and other components in hot environments. Pedestals are typically found in the cooling cavities of airfoils, their primary role being to enhance the pickup of cross flow cooling air. The outer walls of the airfoil benefit by conducting heat towards the pedestals, which in turn are cooled by the convective flow passing over them.

### SUMMARY

In one exemplary embodiment, a gas turbine engine component includes spaced apart walls that provide a cooling passage that extends in a first direction. A pedestal is arranged in the cooling passage and interconnects the walls in a thickness direction that is transverse to the first direction. The pedestal is asymmetrical in the thickness direction.

In a further embodiment of the above, the cooling passage is configured to have a fluid flow direction that is the same as the first direction. An upstream side of the pedestal is canted.

In a further embodiment of any of the above, a downstream side of the pedestal is canted.

In a further embodiment of any of the above, the pedestal is conical in shape.

In a further embodiment of any of the above, the downstream side is canted in the same direction as the upstream side.

In a further embodiment of any of the above, one of the walls is configured to be arranged on a hot side of the component. The upstream side includes upstream and downstream portions. The downstream portion is connected to the one wall.

In a further embodiment of any of the above, the component is one of a blade, vane, combustor liner, augmenter liner, exhaust liner, or blade outer air seal.

In a further embodiment of any of the above, the hot side is a pressure side of an airfoil.

In another exemplary embodiment, a gas turbine engine airfoil includes an exterior wall that provides an exterior surface and includes a cooling passage that extends in a first direction. A pedestal is arranged in the cooling passage and interconnects the walls in a thickness direction that is transverse to the first direction. The pedestal is asymmetrical in the thickness direction.

In a further embodiment of any of the above, the cooling passage is configured to have a fluid flow direction that is the same as the first direction. An upstream side of the pedestal is canted.

In a further embodiment of any of the above, the airfoil extends in a radial direction that corresponds to the first direction.

In a further embodiment of any of the above, a downstream side of the pedestal is canted.

In a further embodiment of any of the above, the pedestal is conical in shape.

In a further embodiment of any of the above, the downstream side is canted in the same direction as the upstream side.

In a further embodiment of any of the above, one of the walls is configured to be arranged on a hot side of the component. The upstream side includes upstream and downstream portions. The downstream portion is connected to the one wall.

In a further embodiment of any of the above, the hot side is a pressure side of the airfoil.

In another exemplary embodiment, a method of manufacturing a gas turbine engine component, includes forming spaced apart walls providing a cooling passage that extends in a first direction. A pedestal is arranged in the cooling passage and interconnects the walls in a thickness direction that is transverse to the longitudinal direction. The pedestal is asymmetrical in the thickness direction.

In a further embodiment of the above, the providing step includes additively manufacturing the airfoil structure.

In a further embodiment of any of the above, the providing step includes additively manufacturing a core that has a shape corresponding to the airfoil structure.

In a further embodiment of any of the above, the shape is a positive of the airfoil structure.

In a further embodiment of any of the above, the shape is a negative of the airfoil structure.

### BRIEF DESCRIPTION OF THE DRAWINGS

The disclosure can be further understood by reference to the following detailed description when considered in connection with the accompanying drawings wherein:

FIG. 1 is a highly schematic view of an example gas turbine engine.

FIG. 2A is a perspective view of the airfoil having the disclosed cooling passage.

FIG. 2B is a plan view of the airfoil illustrating directional references.

FIG. 3 is an enlarged schematic view of an example cooling passage.

FIG. 4A is an enlarged cross-sectional view taken along line 4A-4A in FIG. 3.

FIG. 4B is an enlarged cross-sectional view taken along line 4B-4B in FIG. 3.

FIG. 5 is an enlarged cross-sectional view illustrating another pedestal geometry.

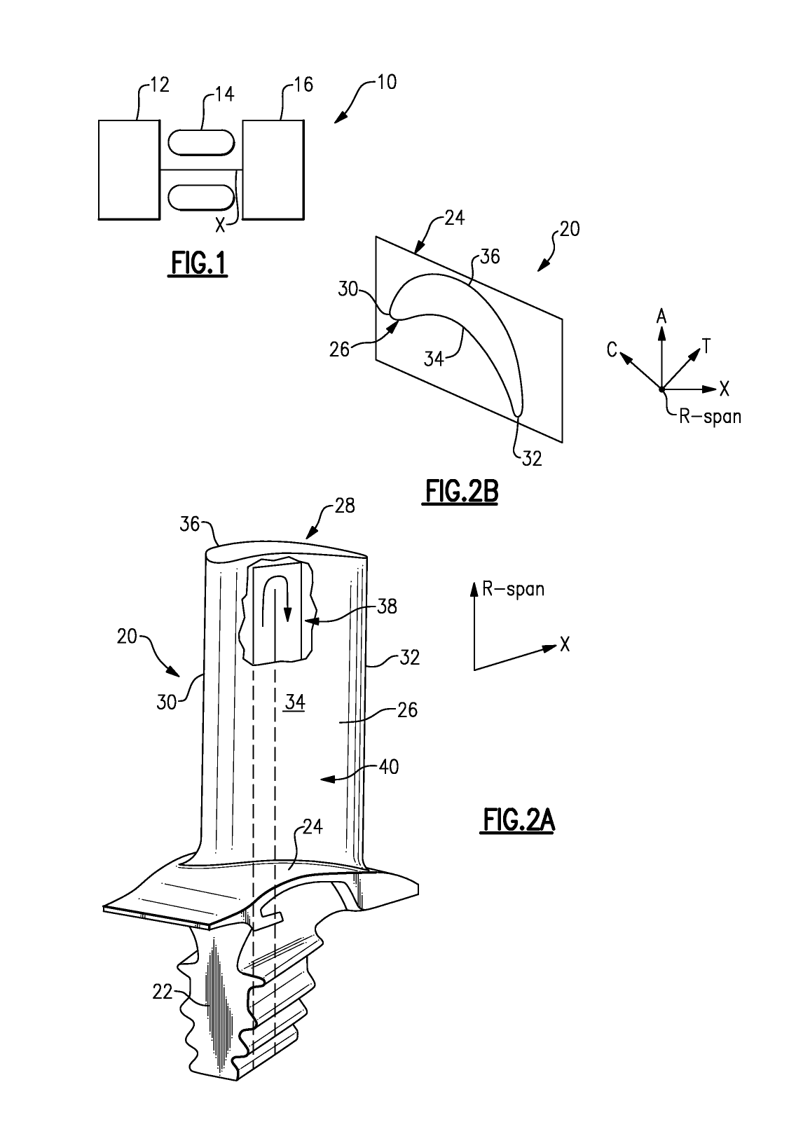

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

The disclosed cooling configuration may be used in various gas turbine engine applications. A gas turbine engine 10 uses a compressor section 12 that compresses air. The compressed air is provided to a combustor section 14 where the compressed air and fuel is mixed and burned. The hot combustion gases pass over a turbine section 16, which is rotatable about an axis X with the compressor section 12, to provide work that may be used for thrust or driving another system component.

Referring to FIGS. 2A and 2B, a root 22 of each turbine blade 20 is mounted to a rotor disk, for example. The turbine blade 20 includes a platform 24, which provides the inner flowpath, supported by the root 22. An airfoil 26 extends in a radial direction R from the platform 24 to a tip 28. It should be understood that the turbine blades may be integrally formed with the rotor such that the roots are eliminated. In such a configuration, the platform is provided by the outer diameter of the rotor. The airfoil 26 provides leading and trailing edges 30, 32. The tip 28 is arranged adjacent to a blade outer air seal.

The airfoil 26 of FIG. 2B somewhat schematically illustrates exterior airfoil surface extending in a chord-wise direction C from a leading edge 30 to a trailing edge 32. The airfoil 26 is provided between pressure (typically concave) and suction (typically convex) wall 34, 36 in an airfoil thickness direction T, which is generally perpendicular to the chord-wise direction C. Multiple turbine blades 20 are arranged circumferentially in a circumferential direction A. The airfoil 26 extends from the platform 24 in the radial direction R, or spanwise, to the tip 28.

The airfoil 18 includes a cooling passage 38 provided between the pressure and suction walls 34, 36. The exterior airfoil surface 40 may include multiple film cooling holes (not shown) in fluid communication with the cooling passage 38.

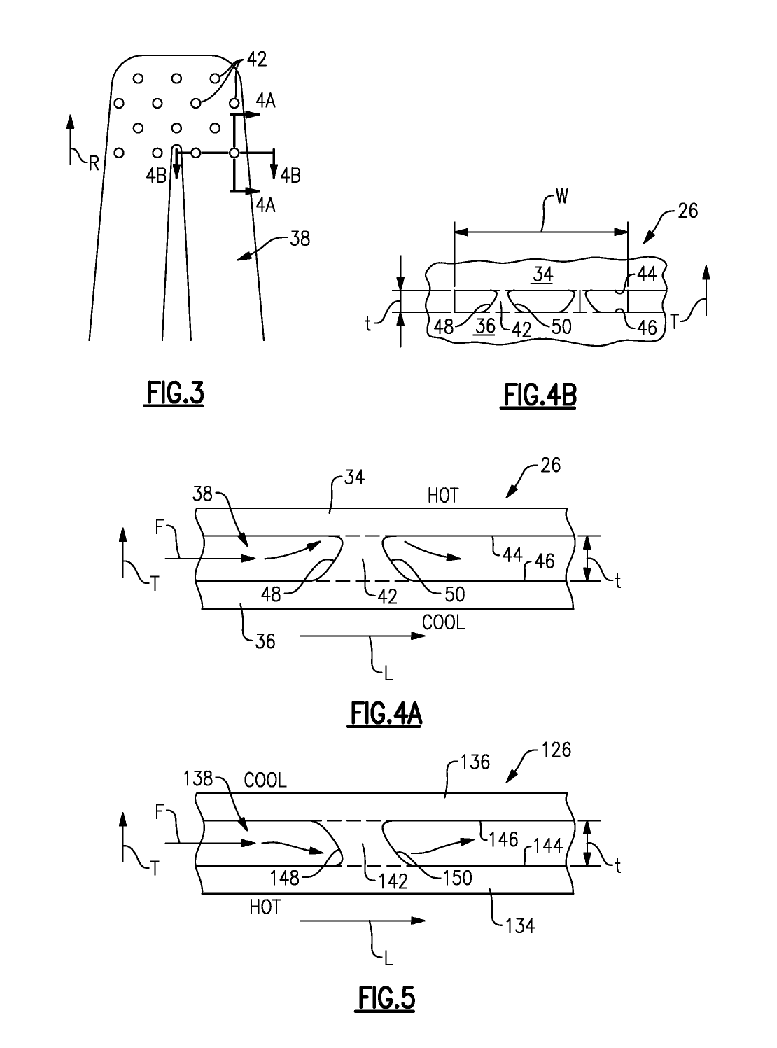

The cooling passage 38 illustrated in FIG. 3 depicts an example arrangement of pedestals 42. It should be understood that any configuration of pedestals may be used in the cooling passage depending upon the application.

Referring to FIGS. 4A and 4B, the pressure and suction side walls 34, 36 respectively provide opposing surfaces 44, 46 which are interconnected to one another by pedestals 42. The cooling passage extends in a first direction or longitudinal direction L, which corresponds to the radial direction R in the example. It should be understood that the longitudinal direction may be oriented in any manner depending upon the application. The surfaces 44, 46 are spaced apart from one another in the thickness direction T, a thickness t and is transverse to a first direction, such as the longitudinal direction L. The pedestal 42 is asymmetrical in the thickness direction T, which is the narrowest dimension that provides the cooling passage in one example.

“Asymmetrical” means that the pedestal material is intentionally distributed asymmetrically about midpoint of its cross-section through the thickness direction T. Such a pedestal will not possess a plane of symmetry anywhere that is normal to its cross-section. The asymmetrical pedestals are used in cooling passages in which the thickness t is less than 30 mils (0.76 mm) and a width W is around 100-500 mils (2.54-12.70 mm).

A fluid F flows in the longitudinal direction. An upstream side 48 of the pedestal 42 is canted in such a manner so as to encourage the flow F toward a hot side of the structure, in the example of an airfoil, the pressure side wall 34.

A downstream side of the pedestal may also be canted. In the example shown in FIGS. 4A-4B, the pedestal 42 has a conical shape such that a downstream side 50 is canted in the opposite direction as the upstream side.

Another example component 126 is illustrated in FIG. 5. The component is one of a blade, vane, combustor liner, augmentor liner, exhaust liner or blade outer air seal. The component 126 includes spaced apart walls 134, 136, respectively, including opposing surfaces 144, 146. The wall 134 is arranged on a hot side, for example, that is exposed to an exhaust gas flow. The upstream side 148 of the pedestal 142 is canted toward the wall 134, and the downstream side 150 is also canted toward the wall 134 in the same direction. In the example, the pedestal 142 provides a leaning cylindrical geometry. It should be understood, however, that the pedestals 42, 142 need not have a circular cross-section and may be any suitable shape.

Pedestals that are purposefully made asymmetric can skew the flow path in such a way as to have predictable consequences on the heat transfer augmentation to the adjacent walls. Situations may arise when traditionally designed pedestal arrays, consisting of individual pedestals which possess a plane of symmetry about the midpoint of their cross sections, struggle to meet particular augmentation goals. In these situations, a designer may be afforded more flexibility by the use of asymmetric pedestals, or pedestals having no plane of symmetry about the midpoint of their cross-sections in the thickness direction. For example, when high heat transfer augmentation is required on the pressure-side wall of a region of an airfoil only, an asymmetric pedestal array consisting of individual pedestals having larger than usual fillets on the suction side while retaining nominal fillets on the pressure side can be used to adjust the flow path preferentially towards the pressure side. Adjust flow in this manner can increase the augmentation on the pressure side wall while decreasing it on the suction side wall, maintain high convective cooling on the side that needs it while mitigating coolant heat pick up. Similar schemes can be devised using combinations of asymmetric pedestals within an array.

Asymmetrical pedestals can provided the ability to tailor heat transfer characteristics within low aspect ratio pedestal array regions of an airfoil, provide more efficient use of cooling flow if volume of pedestal is kept constant, and provide potential for decreased weight if volume of pedestal is reduced by more efficient use of pedestal.

It may be manufactured by traditional casting or by an additive technique. It may or may not be a single material and may or may not be of the same material as the airfoil wall to which it is joined.

The cooling configuration employs relatively complex geometry that may not be formed easily by traditional casting methods. To this end, additive manufacturing techniques may be used in a variety of ways to manufacture gas turbine engine component, such as an airfoil, with the disclosed cooling configuration. The structure can be additively manufactured directly within a powder-bed additive machine (such as an EOS 280). Alternatively, cores that provide the structure shape can be additively manufactured. Such a core could be constructed using a variety of processes such as photo-polymerized ceramic, electron beam melted powder refractory metal, or injected ceramic based on an additively built disposable core die. The core and/or shell molds for the airfoils are first produced using a layer-based additive process such as LAMP from Renaissance Systems. Further, the core could be made alone by utilizing EBM of molybdenum powder in a powder-bed manufacturing system.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A gas turbine engine component comprising:
spaced apart walls providing a cooling passage that extends in a first direction, a pedestal is arranged in the cooling passage and interconnects the walls in a thickness direction that is transverse to the first direction, the pedestal is asymmetrical in the thickness direction.

2. The component according to claim 1, wherein the cooling passage is configured to have a fluid flow direction that is the same as the first direction, an upstream side of the pedestal is canted.

3. The component according to claim 2, wherein a downstream side of the pedestal is canted.

4. The component according to claim 3, wherein the pedestal is conical in shape.

5. The component according to claim 3, wherein the downstream side is canted in the same direction as the upstream side.

6. The component according to claim 2, wherein one of the walls is configured to be arranged on a hot side of the component, the upstream side including upstream and downstream portions, the downstream portion connected to the one wall.

7. The component according to claim 6, wherein the component is one of a blade, vane, combustor liner, augmenter liner, exhaust liner, or blade outer air seal.

8. The component according to claim 7, wherein the hot side is a pressure side of an airfoil.

9. A gas turbine engine airfoil comprising:
an exterior wall providing an exterior surface and including a cooling passage that extends in a first direction, a pedestal is arranged in the cooling passage and interconnects the walls in a thickness direction that is transverse to the first direction, the pedestal is asymmetrical in the thickness direction.

10. The airfoil according to claim 9, wherein the cooling passage is configured to have a fluid flow direction that is the same as the first direction, an upstream side of the pedestal is canted.

11. The airfoil according to claim 10, wherein the airfoil extends in a radial direction that corresponds to the first direction.

12. The airfoil according to claim 10, wherein a downstream side of the pedestal is canted.

13. The airfoil according to claim 12, wherein the pedestal is conical in shape.

14. The airfoil according to claim 12, wherein the downstream side is canted in the same direction as the upstream side.

15. The airfoil according to claim 10, wherein one of the walls is configured to be arranged on a hot side of the component, the upstream side including upstream and downstream portions, the downstream portion connected to the one wall.

16. The airfoil according to claim 15, wherein the hot side is a pressure side of the airfoil.

17. A method of manufacturing a gas turbine engine component, comprising:
forming spaced apart walls providing a cooling passage that extends in a first direction, a pedestal is arranged in the cooling passage and interconnects the walls in a thickness direction that is transverse to the longitudinal direction, the pedestal is asymmetrical in the thickness direction.

18. The method according to claim 17, wherein the providing step includes additively manufacturing the airfoil structure.

19. The method according to claim 17, wherein the providing step includes additively manufacturing a core having a shape corresponding to the airfoil structure.

20. The method according to claim 19, wherein the shape is a positive of the airfoil structure.

21. The method according to claim 19, wherein the shape is a negative of the airfoil structure.
